(19) United States
(12) Patent Application Publication
(10) Pub. No.: US 2023/0163975 A1
(43) Pub. Date: May 25, 2023

(54) Certifying Public Keys for Multiple Cryptographic Hash Trees

(71) Applicant: ISARA Corporation, Waterloo (CA)

(72) Inventors: Shane Daniel Kelly, Waterloo (CA); Alexander Truskovsky, Waterloo (CA)

(73) Assignee: ISARA Corporation, Waterloo (CA)

(21) Appl. No.: 17/535,460

(22) Filed: Nov. 24, 2021

(51) Int. Cl. H04L 9/32; H04L 9/08; H04L 9/06

(52) U.S. Cl. CPC H04L 9/3247; H04L 9/0825; H04L 9/3263; H04L 9/3228; H04L 9/0836; H04L 9/0643

(57) ABSTRACT

In a general aspect, a plurality of cryptographic hash trees is generated. Each hash tree includes a root node and a plurality of leaf nodes. The leaf nodes are generated from verification keys for a one-time signature scheme. The hash trees are stored on hardware security modules. Public keys are generated for each of the hash trees. A composite public key is then generated for the plurality of hash trees such that the composite public key includes the plurality of public keys. A digital certificate that certifies the composite public key is obtained, the digital certificate including the composite public key and a digital signature of a certificate authority.

### BACKGROUND

The following description relates to certifying public keys for multiple cryptographic hash trees.

Cryptography systems are used to communicate securely over public channels. For example, some cryptosystems provide confidentiality by encrypting messages, and some cryptosystems provide authenticity through digital signatures. Many cryptosystems include protocols that use cryptographic keys. For example, in a public key infrastructure (PKI), the cryptographic keys include public and private keys for each entity, and a certificate authority can issue digital certificates to certify the public keys.

### DESCRIPTION OF DRAWINGS

FIG. 1 is a block diagram showing aspects of an example computing environment.

FIG. 2 is a diagram showing an example process of generating a certificate for a composite public key for two cryptographic hash trees.

FIG. 3 is a flowchart showing an example process of generating a certificate for a composite public key.

### DETAILED DESCRIPTION

In some aspects of what is described here, public keys associated with multiple distinct cryptographic hash trees are certified in a single digital certificate. In some examples, the public keys are combined to form a composite public key, which is provided in the public key field of a digital certificate (e.g., an X.509 certificate or another type of standardized digital certificate). The cryptographic hash trees can be generated independently by distinct hardware security modules (HSMs), and may be used independently in a one-time signature (OTS) scheme. In this manner, public keys associated with multiple independently-generated cryptographic hash trees can be certified by the same digital certificate.

Hash-based signature (HBS) schemes generally fall into two types: stateful and stateless. In a stateful HBS scheme, an HBS private key set includes a large set of OTS private keys. The signer needs to ensure that no individual OTS key is used to sign more than one message. If an attacker were able to obtain digital signatures for two different messages that were created using the same OTS key, then it could become computationally feasible for that attacker to forge signatures on arbitrary messages. Consequently, the system should keep track of which OTS keys have been used. Stateless hash-based signature algorithms allow a “few-times” key to be used more than once, in an effort to avoid the complexity of managing OTS keys.

Stateful hash-based signature schemes utilize a collection of one-time signing and verification key pairs. Multiple verification keys can be combined to yield a single public key. Since an OTS scheme key can only securely sign a single message, it may be practical to combine many such one-time key pairs within a larger structure. This makes the collection more manageable, because the verifier has only a single composite public key to trust. Hash-based signature schemes can combine a larger number of OTS key pairs into a single structure as a way of obtaining a practical way of signing (albeit a finite number of times) more than once. The single structure can be a cryptographic hash tree or Merkle tree structure, a tree in which each leaf node is labeled with the cryptographic hash of a data block, and each non-leaf node is labeled with the cryptographic hash of the labels of its child nodes. In such a hierarchical data structure, a hash function and concatenation are used repeatedly to compute tree nodes. One public key is constructed from the numerous signing and verification keys of the underlying one-time scheme. The global public key is or includes the single node at the root of the tree.

Stateful hash-based signature schemes can be secure against both classical and quantum computer-enabled attacks. However, a first challenge with these schemes arises from the fact that the set of private keys is finite (exhaustible). Selection of a tree height needs to ensure enough keys (signatures) are available for the lifetime of the tree of keys. If the key is used to sign other keys, e.g., it is used to sign Root or Intermediate certificates, then a certain number of signatures should be reserved for possible certificate revocation. A second challenge concerns the bookkeeping of the private key state. A careful atomic record needs to be kept of each used signing key. Once a signing key has been used, it should be discarded and not used again because key reuse can lead to scheme compromise.

A simple means for deploying a stateful hash-based signature scheme is to store the entire tree in a single Hardware Security Module (HSM). For example, a public key can be placed in a digital certificate. This mechanism may be useful for end-entity certificates, because end-entity certificates are used strictly for the purpose they were created, e.g., code signing. If the HSM fails, the signer can simply generate another key (perhaps in another HSM) and have it certified by a Certificate Authority (CA). The signer can then continue signing code as it did before the first HSM failure. This method cannot be employed for a CA, however, as it needs to ensure that enough signing keys are reserved to revoke previously issued certificates.

State management and exhaustion of the private keys can be especially challenging when considering High Availability and Disaster Recovery. High Availability (HA) utilizes a tree that is partitioned into multiple HSMs to support large numbers of signing requests. However, in such a configuration, state management can become expensive and error prone. Disaster Recovery (DR) schemes anticipate an HSM failure in which a part of the exhaustible private key store is lost forever.

In some contexts, splitting a tree into multiple sub-trees presents several challenges. First, even though each HSM is responsible for its own sub-tree, it is not impossible to accidentally use a signing key from a different sub-tree. Also, the National Institute of Standards and Technology (NIST) has recently updated its guidance on stateful Hash-based Signatures (Special Publication 800-208) which disallows, for security reasons, exporting all or part of a private key tree (out of an HSM) after it has been generated.

Thus, techniques that utilize tree splitting techniques or exporting parts of the private key are either disallowed or are impractical. In some cases, a solution that obviates tree splitting and/or key export may be achieved at a protocol/certificate level. As described here, full cryptographic hash trees can be generated in separate HSMs. These trees may be of the same or different size, depending on a key usage plan. The public keys (root nodes) of the individual trees can them be combined into a single public key. The combination can be achieved by concatenation, in which the key size is increased, e.g., Composite Public Key=pk₁|pk₂| . . . |pkₙ. Alternatively, the composite public key can be hashed to maintain the size of the public key at the size of a single key, e.g., Composite Public Key=HASH(pk₁|pk₂| . . . |pkₙ). When combining trees of the same type, the type information can be stored as a global attribute in the certificate. When combining trees of different types, the tree can be stored either within the structure concatenating the public keys or in a global attribute specifying the tree order.

The systems and techniques described here, which may be implemented at a protocol or certificate level, provide several benefits over existing schemes. First, there is no need to manage parts of the same tree that have been partitioned to separate HSMs. Consequently, the risk of accidental key reuse can be eliminated. Second, the operational and security challenges of splitting a tree after generation are reduced or avoided. The security risk of exporting a private key outside an HSM can also be avoided, and NIST compliance can be achieved. Third, key usage planning can be simplified to determining the number of trees and their sizes, rather than requiring the partitioning of a single large tree. Finally, using multiple smaller trees and a composite public key (generated, e.g., by hashing the chained public keys) can reduce the size of the signature. Alternatively, the signature size may depend on the number and size of the individual trees for the case in which the individual public keys are only concatenated.

Accordingly, aspects of the systems and techniques described here can be used to improve the operation of communications systems (e.g., data networks, etc.), computer systems (e.g., network-connected computers, etc.), smart devices (e.g., so-called “Internet-of-Things” (IoT) devices, etc.), and other classes of technology. For example, a wide variety of modern technologies rely on computer-implemented digital signature schemes for secure operation, and the techniques described here can improve such computer-implemented schemes, for example, making them more computationally efficient, more secure, more compliant with standards, or providing other advantages in some instances.

In some aspects, the certificate schemes described here can be extended to other types of public keys. For example, public keys associated with multiple distinct cryptosystems may be combined to form a composite public key in the public key field of a digital certificate (e.g., an X.509 certificate or another type of standardized digital certificate), so that the digital certificate can be used with each of the distinct cryptosystems (e.g., an Elliptic Curve Cryptography (ECC) system, an RSA cryptography system, an isogeny-based cryptography system, a lattice-based cryptography system, a code-based cryptography system, etc). In such cases, the composite public key is constructed from multiple public keys associated with the respective cryptosystems. In this manner, public keys associated with multiple distinct cryptosystems can be certified by the same digital certificate. This type of digital certificate may be useful in a variety of contexts, for example, in an upgrade or transition between cryptosystems. For instance, when an enterprise is transitioning from a quantum-vulnerable cryptosystem to a quantum-secure cryptosystem, hybrid digital certificates that can be used with both cryptosystems can be generated to certify composite public keys.

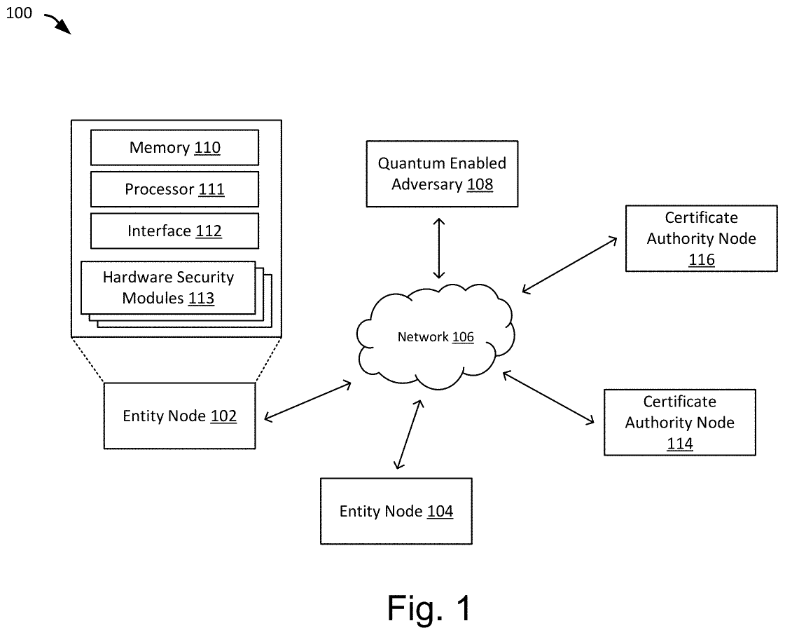

FIG. 1 is a block diagram showing aspects of an example computing environment 100. The example computing environment 100 shown in FIG. 1 includes four nodes—two entity nodes 102, 104, and two certificate authority nodes 112, 114. The nodes use a cryptographic scheme to communicate with each other over a network 106. In the example shown, a quantum-enabled adversary 108 has access to the network 106, information exchanged on the network 106, or both. In some instances, the quantum-enabled adversary can modify information on the network 106. The computing environment 100 may include additional or different features, and the components in a computing environment may be configured to operate as shown in FIG. 1 or in another manner.

Nodes in the computing environment 100 may have a client-server relationship. For example, the node 102 can be a server and the node 104 can be its client in a client-server network, or vice-versa. In some implementations, nodes in the computing environment 100 may have a peer-to-peer relationship. For example, the nodes 102, 104 can be peers in a client-server network, in a peer-to-peer network, or another type of network. Nodes may have another type of relationship in the computing environment 100.

In some instances, the computing environment 100 uses a public key infrastructure (PKI) for cryptographic correspondence. In a typical public key infrastructure (PKI), entities can authenticate each other based on certificates issued by trusted certificate authorities. The entities in the PKI (e.g., users, user accounts, devices or machines, software modules, or other types of entities) each have a user identity and a key pair that includes a public key and a private key, and a certificate authority can issue a digital certificate to bind the public key to the entity's user identity.

In some example PKIs, there are two types of digital certificates—certificate authority (CA) certificates and end-entity certificates. A CA certificate can be used to authenticate other certificates. An end-entity certificate can be used to identify an entity (the certificate owner). In the example shown in FIG. 1, each of the entity nodes 102, 104 can be associated with an entity that has an end-entity certificate, and each of the certificate authority nodes 112, 114 can be associated with a certificate authority that has a CA certificate.

Some example PKIs use certificate chains. In a typical certificate chain, a root CA certificate resides at the top of the certificate chain, an end-entity certificate resides at the bottom of the certificate chain, and one or more intermediate CA certificates reside in the middle of the certificate chain (between the root CA certificate and the end-entity certificate). A root CA certificate can be hardcoded and explicitly trusted by the entities in the PKI. An end-entity certificate can be issued to an entity in the PKI and contain the entity's user identity. In some instances, a root certificate authority may issue intermediate CA certificates to subordinate certificate authorities, or a root certificate authority may issue end-entity certificates. In some instances, an intermediate certificate authority may issue intermediate CA certificates to subordinate certificate authorities, or an intermediate certificate authority may issue end-entity certificates. As an example, the certificate authority node 112 in FIG. 1 may be associated with a root certificate authority that has a root CA certificate, and the root certificate authority may issue an intermediate CA certificate to a certificate authority associated with the other certificate authority node 114. The intermediate certificate authority may issue end-entity certificates to entities associated with the entity nodes 102, 104.

In the example shown in FIG. 1, the example entity nodes 102, 104 and the certificate authority nodes 112, 114 each have computational resources (e.g., hardware, software, firmware) that are used to communicate with other nodes. In some implementations, nodes in the computing environment 100 can be implemented in various systems, such as, for example, laptops, desktops, workstations, smartphones, tablets, personal digital assistants, servers, server clusters, mainframes, and other types of computer systems. As shown in FIG. 1, the example node 102 includes a memory 110, a processor 111 and an interface 113. Each of the entity nodes 102, 104 and the certificate authority nodes 112, 114 may include the same, additional, or different components. The entity nodes 102, 104 and the certificate authority nodes 112, 114 may be configured to operate as shown and described with respect to FIG. 1 or in another manner. In some cases, a single device may operate both as an entity node and as a certificate authority node.

In the example node 102 shown in FIG. 1, the memory 110 can include, for example, random access memory (RAM), a storage device (e.g., a writable read-only memory (ROM) or others), a hard disk, or another type of storage medium. The example memory 110 can store instructions (e.g., computer code, a computer program, etc.) associated with an operating system, computer applications, and other resources. The memory 110 can also store application data and data objects that can be interpreted by one or more applications or virtual machines running on the node 102. The node 102 can be preprogrammed, or it can be programmed (and reprogrammed), by loading a program from another source (e.g., from a DVD-ROM, from a removable memory device, from a remote server, from a data network or in another manner). In some cases, the memory 110 stores computer-readable instructions for software applications, scripts, programs, functions, executables, or other modules that are interpreted or executed by the processor 111.

In the example node 102 shown in FIG. 1, the processor 111 can execute instructions, for example, to generate output data based on data inputs. For example, the processor 111 can run computer programs by executing or interpreting the software, scripts, programs, functions, executables, or other modules stored in the memory 110. The example processor 111 shown in FIG. 1 can include one or more chips or chipsets that include analog circuitry, digital circuitry, or a combination thereof. In some cases, the processor 111 includes multiple processor devices such as, for example, one or more main processors and one or more co-processors. For instance, the processor 111 may include a main processor that can delegate certain computational tasks to a cryptographic co-processor, which may be configured to perform the computational tasks more efficiently than the main processor or in parallel with other computational tasks performed by other processor devices. In some instances, the processor 111 coordinates or controls operation of other components of the node 102, such as, for example, user interfaces, communication interfaces, peripheral devices, and possibly other components.

In the example node 102 shown in FIG. 1, the interface 113 provides communication with other nodes or devices. In some cases, the interface 113 includes a wireless communication interface that provides wireless communication under various wireless protocols, such as, for example, Bluetooth, Wi-Fi, Near Field Communication (NFC), GSM voice calls, SMS, EMS, or MMS messaging, wireless standards (e.g., CDMA, TDMA, PDC, WCDMA, CDMA2000, GPRS) among others. Such communication may occur, for example, through a radio-frequency transceiver or another type of component. In some cases, the interface 113 includes a wired communication interface (e.g., USB, Ethernet) that can be connected to one or more input/output devices, such as, for example, a keyboard, a pointing device, a scanner, or a networking device such as a switch or router, for example, through a network adapter.

The example network 106 can include all or part of a connector, a data communication network, or another type of communication link. For example, the network 106 can include one or more wired or wireless connections, one or more wired or wireless networks or other communication channels. In some examples, the network 106 includes a Local Area Network (LAN), a Wide Area Network (WAN), a private network, a Virtual Private Network (VPN), a public network (such as the Internet), a peer-to-peer network, a cellular network, a Wi-Fi network, a Personal Area Network (PAN) (e.g., a Bluetooth low energy (BTLE) network, a ZigBee network, etc.) or other short-range network involving machine-to-machine (M2M) communication, or another type of data communication network.

The nodes in the example computing environment 100 include secure communication modules (e.g., a Virtual Private Network (VPN), secure web browsing, secure mail, etc.) or other types of system components that use the PKI for authentication and use the related cryptographic keys for identification (e.g., in a digital signature-based zero-knowledge proof or another type of identification mechanism) to establish the trusted identity of participating entities. The security of such authentication and identification mechanisms may rely on one or more cryptography systems (“cryptosystems”). Examples of crypto-systems include a variety of RSA-based cryptosystems, ECC-based cryptosystems, lattice-based cryptosystems, code-based cryptosystems, isogeny-based cryptosystems, and others. A cryptosystem typically defines a set of cryptographic protocols and parameters to be used in the cryptographic protocols.

In the example shown, the quantum-enabled adversary 108 has access to quantum computational resources. For example, the quantum-enabled adversary 108 can be, include, or have access to a quantum computer, a quantum information processor, a quantum memory, a quantum communication interface, or a combination of these and possibly other quantum technologies. In some implementations, the quantum-enabled adversary 108 can include a hybrid computing system, for instance, that includes a quantum processor driven by a classical front-end processor, or another type of hybrid computing system.

In some examples, the quantum-enabled adversary 108 can store and process information in a quantum system. For instance, the quantum-enabled adversary 108 may encode information as quantum bits (“qubits”) and process the information by manipulating the qubits. The information may be encoded in physical qubits, logical qubits, or a combination of these and other types of qubit encodings. In some implementations, the quantum-enabled adversary 108 can operate in a fault-tolerant regime, or the quantum-enabled adversary may operate below the fault-tolerant regime.

Many public-key cryptography systems are known to be insecure against an attacker armed with a scalable quantum computer. For example, the Diffie-Hellman (DH) and elliptic curve Diffie-Hellman (ECDH) key agreement protocols are vulnerable to certain types of attacks by quantum-enabled adversaries. The threat of quantum computers to public key cryptography can be mitigated by switching to other public key cryptosystems that are believed to be invulnerable to quantum attack. For example, lattice-based cryptosystems have been proposed as quantum-resistant replacements for certain RSA-based or ECC-based cryptosystems that are believed to be quantum-vulnerable. In addition, hash based signature (HBS) schemes that utilize one-time signatures can also be implemented in a manner that is secure against quantum-enabled attacks.

In some implementations, the example quantum-enabled adversary 108 can perform quantum computing algorithms, execute quantum computing circuits or quantum communication protocols, or perform other types of quantum information processing tasks. In the example shown, the quantum-enabled adversary 108 can perform Shor's algorithm, which allows the quantum-enabled adversary to efficiently solve problems that are believed to be hard on a classical computer. For example, the quantum-enabled adversary 108 may use Shor's algorithm to factor large integers, find discrete logarithms, or possibly to solve other problems in a computationally efficient manner. Accordingly, the example quantum-enabled adversary 108 can compromise the security of certain quantum-vulnerable cryptosystems (e.g., by computing a private key of a certificate authority or other entity based on public information).

The example quantum-enabled adversary 108 shown in FIG. 1 can access information exchanged on the network 106. For example, the quantum-enabled adversary 108 may access some or all of the information exchanged between the entity nodes 102, 104 or between an entity node and a certificate authority node. In some instances, the quantum-enabled adversary 108 can directly observe correspondence on the network 106; in some instances, the quantum-enabled adversary 108 indirectly obtains such correspondence, for example, by receiving information observed on the network 106 by another entity or system.

In some implementations, the quantum-enabled adversary 108 can factor integers, compute discrete logarithms, or perform other classically-hard computational tasks fast enough to compromise the security of certain cryptography systems. For example, the quantum-enabled adversary 108 may be capable of computing prime factors fast enough to compromise certain RSA encryption standards or computing discrete logarithms fast enough to compromise certain ECC encryption standards.

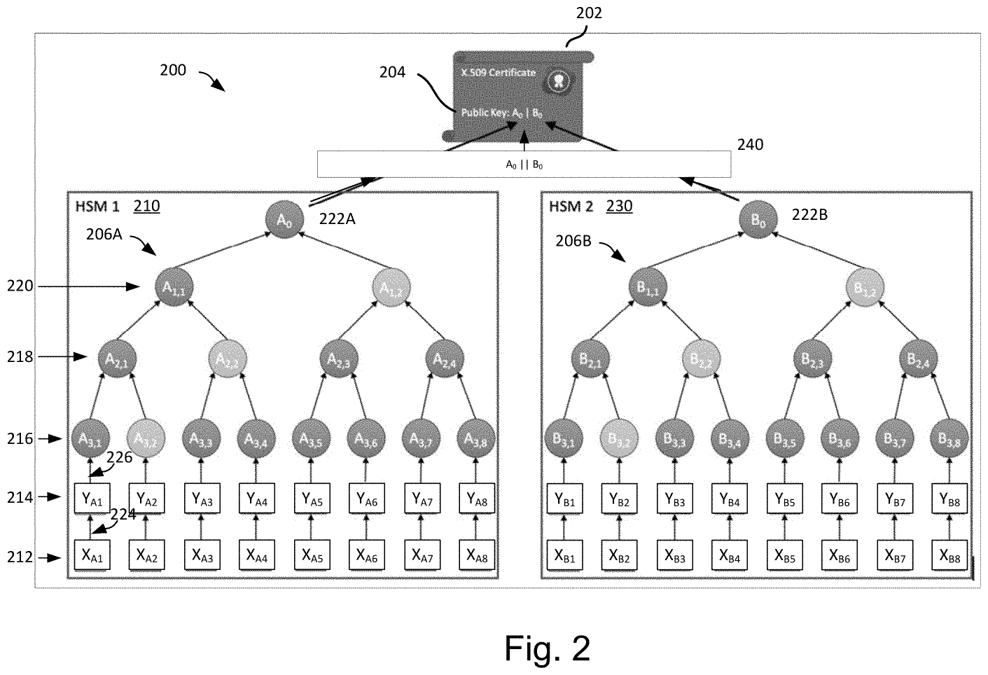

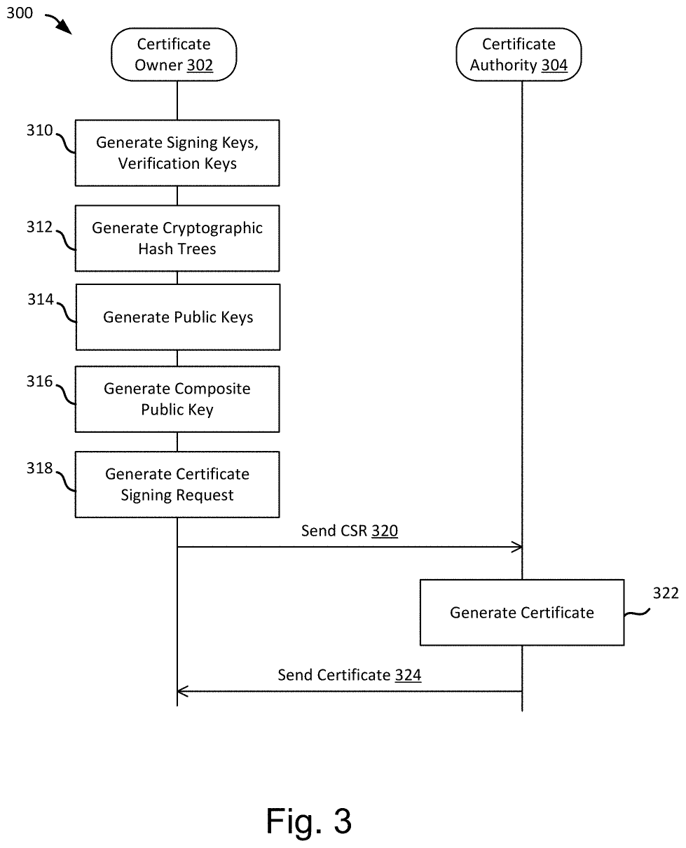

In the example shown in FIG. 1, the computing environment 100 can utilize a digital signature scheme, in which public keys are certified by digital certificates issued by the certificate authority nodes 114, 116. The digital signature scheme can be a hash based signature (HBS) scheme that utilizes signing keys and verification keys for one-time signatures. A cryptographic hash tree can be generated to produce a public key for a set of signing keys and verification keys, and the cryptographic hash tree can be used along with the public key to verify the signing keys and verification keys. Multiple public keys (associated with respective cryptographic hash trees) can be combined to form a composite public key that is certified in a digital certificate issued by one of the certificate authority nodes 114, 116. Example processes for generating digital certificates are described with respect to FIGS. 2 and 3; other types of processes may be used.

FIG. 2 is a diagram showing an example process 200 of generating a digital certificate for a composite public key for two cryptographic hash trees 206A, 206B. In the example shown in FIG. 2, the digital certificate 202 is an X.509 certificate that is generated to certify a composite public key 204. The digital certificate 202 may be generated by a Certificate Authority, for example, by either of the certificate authority nodes 114, 116 shown in FIG. 1. The example composite public key 204 shown in FIG. 2 is a concatenation of two public keys, which include the root nodes A₀ and B₀ of the cryptographic hash trees 206A and 206B, respectively. Each cryptographic hash tree 206A and 206B is a binary tree of height H, the height representing the number of tiers of non-leaf nodes in the tree. The height of the tree may be determined by taking the cube root of the number of signing keys to be supported by the cryptographic hash tree. For example, a cryptographic hash tree of height H=3 can be generated from eight signing keys. Similarly, a cryptographic hash tree of height H=5 can be generated from 32 signing keys. A level L of the cryptographic hash tree may be designated by the distance between the level and the root node of the cryptographic hash tree.

In the example shown in FIG. 2, the cryptographic hash trees 206A and 206B are based on signing and verification keys for an OTS scheme. Each non-root node of the cryptographic hash trees 206A and 206B shown in FIG. 2 is designated with two comma-separated subscript numerals, in which the first subscript numeral denotes the level L of the node within the cryptographic hash tree and the second subscript numeral denotes the position of the node within a particular level L of the cryptographic hash tree. The root nodes A₀ and B₀ of the cryptographic hash trees 206A and 206B, respectively, have only a first subscript numeral indicating the level L=0 of the cryptographic hash tree. In FIG. 2, lower-level nodes of the cryptographic hash trees 206A and 206B are designated with higher first subscript numerals. For example, the lowest levels of the cryptographic hash trees 206A and 206B are designated as L=3, and the highest levels of the cryptographic hash trees 206A and 206B are designated as L=0. The root node 222A of the cryptographic hash tree 206A (A₀ in FIG. 2) resides at the top of the cryptographic hash tree 206A. Similarly, the root node 222B of the cryptographic hash tree 206B (B₀ in FIG. 2) resides at the top of the cryptographic hash tree 206B.

FIG. 2 illustrates that cryptographic hash tree 206A is generated from eight signing keys, designated X_{A1} to X_{A8}. A function is applied to the eight signing keys, resulting in eight verification keys designated X_{A1} to Y_{A8}. These eight verification keys are then hashed to produce the leaf nodes A_{3,1}-A_{3,8}. Cryptographic hash tree 206A has a height H of three, indicating three non-leaf node tiers. The nodes of these tiers are designated A_{n,m}, with n specifying level L−1 of the tree (the root node of the tree is designated level 0) and m indicating the sequence of the node within the level. For example, in FIG. 2, A_{2,2} represents the second node of the third level of the tree. Adjacent pairs of sibling leaf nodes are concatenated and hashed to produce each parent node in the cryptographic hash tree 206A. The levels/tiers of the cryptographic hash tree 206A can be iteratively constructed by repeating the process of concatenating child nodes and hashing the result until a root node A₀ is obtained, as illustrated in FIG. 2.

A non-leaf node of the cryptographic hash tree can be constructed by the application of a hash function to a combination of the node's two child nodes. In some cases, the hash function may be a different function than that used to generate the leaf nodes from the verification keys. In some cases, the hash function may be the same function as that applied to the verification keys to generate the leaf nodes. For example, as illustrated in FIG. 2, the value of a node at level 218 may be determined by applying a hash function to the concatenation of the values of its two child nodes (at level 216) (e.g., [symbol] A_{1,1} [symbol] A_{2,1} [symbol] ∥ [symbol] A_{2,2} [symbol] ), where ∥ indicates concatenation). The levels/tiers of the HASH( [symbol] A_{2,1} [symbol] || [symbol] A_{2,2} [symbol] ), where ∥ indicates concatenation). The levels/tiers of the cryptographic hash tree 206A may be iteratively constructed by repeating the process of concatenating child nodes and hashing the result until a root node A₀ is obtained, as illustrated in FIG. 2. The cryptographic hash tree 206B may be similarly constructed by iteratively concatenating child nodes and hashing the results until a root node B₀ is obtained.

In some instances, a cryptographic hash tree 206A may be both generated and stored within a hardware security module (HSM) 210. An HSM may be implemented as a physical computing device that safeguards and manages digital keys, performs encryption and decryption functions for digital signatures, strong authentication, and other cryptographic functions. HSMs may come in the form of a plug-in card or an external device that attaches directly to a computer or network server. A hardware security module may contain one or more secure cryptographic co-processors and possibly other specialized hardware components.

HSMs may have features that provide tamper evidence such as visible signs of tampering or logging and alerting, tamper resistance that makes tampering difficult without making the HSM inoperable, or tamper responsiveness such as deleting keys upon tamper detection. An HSM may contain one or more secure crypto-processor chips to prevent tampering and bus probing, or a combination of chips in a module that is protected by the tamper evident, tamper resistant, or tamper responsive packaging.

FIG. 2 further illustrates a second HSM 230 that contains a second cryptographic hash tree 206B, the root node designated B₀. Similar to cryptographic hash tree 206A, cryptographic hash tree 206B is generated from eight signing keys, designated X_{B1} to X_{B8}. A function is applied to the eight signing keys, resulting in eight verification keys designated Y_{B1} to Y_{B8}. These eight verification keys are then hashed to produce the leaf nodes B_{3,1}-B_{3,8}. Cryptographic hash tree 206B has a height H of three, indicating three non-leaf node tiers. The nodes of these tiers are designated B_{n,m}, with n specifying level L−1 of the tree (the root node of the tree is designated level 0) and m indicating the sequence of the node within the level. For example, in FIG. 2, B_{2,2} represents the second node of the third level of the tree. Adjacent pairs of sibling leaf nodes are concatenated and hashed to produce a parent node. The levels/tiers of the cryptographic hash tree 206B are iteratively constructed by repeating the process of concatenating child nodes and hashing the result until a root node B₀ is obtained, as illustrated in FIG. 2.

As shown in FIG. 2, the lowest-level (leaf) nodes 216 of the cryptographic hash trees 206A and 206B are based on respective verification keys 214 of an OTS scheme, and each verification key 214 is based on a respective signing key 212 of the OTS scheme. Respective signing keys 212 and verification keys 214 may form signing/verification key pairs. For instance, X_{A1} is a first signing key of the OTS scheme, Y_{A1} is a first verification key that is based on the first signing key X_{A1}, and (X_{A1}, Y_{A1}) may be considered a first signing/verification key pair of the OTS scheme. Likewise, X_{A2} is a second signing key of the OTS scheme, Y_{A2} is a second verification key that is based on the second signing key X_{A2}, and (X_{A2}, Y_{A2}) may be considered a second signing/verification key pair of the OTS scheme. The leaf node A_{3,1} is based on verification key Y_{A1} and leaf node A_{3,2} is based on verification key Y_{A2}. In the example shown, each leaf node 216 is based on the output of a hash function 226 applied to a respective verification key 214. Each verification key 214 is based on the output of a function 224 applied to a respective signing key 212.

The hash function 226 may be any suitable secure hash function. A secure hash function may be implemented by a hash function that is generally pre-image resistant or second pre-image resistant. An example secure hash function is the SHA-256 function or SHA3-256 function. In some implementations, the hash function 226 produces an output that is smaller than an input to the hash function 226. For instance, referring to FIG. 2, each leaf node 216 may be smaller in size (e.g., 32 bytes) than the verification key 214 (e.g., 16 kB) upon which it is based. The function 224 may be any suitable function that takes a signing key 212 for an OTS scheme as input and generates a verification key 214 of the OTS as output. In some implementations, the function 224 produces an output that is the same size as an input to the function 224. For instance, referring to FIG. 2, each signing key 212 may be the same size as the verification keys 214 associated therewith (e.g., 16 kB). The function 224 may be a different function from the hash function 226. The function 224 may be the same function as hash function 226.

In some instances, the function 224 includes the application of a hash function. The hash function may be a secure hash function as described above. For example, in a Lamport-Diffie OTS scheme, the verification keys 214 are based on the output of a hash function applied to respective signing keys 212. In a Lamport-Diffie OTS scheme, each signing key 212 may comprise a set of random values, wherein each random value is associated with a respective bit position of the output of a hash function (the digest) applied to the message being digitally signed. Each random value is based on whether the respective bit position of the digest is of value 0 or 1. The verification key is based on the output of a hash function applied to respective random values of the set of random values in the signing key. The Lamport-Diffie OTS is generated using the signing key and is based on the values of respective bit positions of the digest of the message being digitally signed. The OTS thus comprises the set of random values in the signing key that correspond to the values of the respective bit positions of the digest. To verify the OTS, the same hash function used to generate the verification key is applied to the respective random values in the OTS, and the output is compared to the values in the verification key.

In some instances, the function 224 includes the application of a hash function multiple times. The hash function may be a secure hash function as described above. For example, in a Winternitz OTS scheme, the verification keys 214 are based on the output of a hash function applied multiple times to the signing keys 212. In a Winternitz OTS scheme, each signing key comprises a set of random values, with each random value being associated with multiple bit positions of the message being signed. The verification key 214 is based on the output of the hash function applied multiple times to respective random values of the signing key 212. The Winternitz OTS is generated by applying a hash function one or more times to the random value associated with the respective set of bit positions of the message being signed. The number of times the hash function is applied may depend on the value of the bits in the set of bit positions. To verify the OTS, the same hash function used to generate the verification key 214 is applied one or more times to the OTS, and an output is compared to the verification key 214. The number of times the hash function is applied to the OTS may depend on the value of the bits in the set of bit positions. Other OTS schemes are contemplated and may be used with implementations of the present disclosure.

The non-leaf nodes of the cryptographic hash trees 206A and 206B (the nodes other than the leaf nodes 216) are based on the application of a hash function to a combination of that node's two child nodes. The hash function may be a different hash function from hash function 226. Alternatively, the hash function may be the same hash function as hash function 226. The hash function may be a secure, publicly known hash function, and may be applied to a combination of the two nodes below in any suitable manner. For example, the value of a node at level L=2 may be determined by applying a hash function to the concatenation of the values of the two nodes directly below it at level L=3 (e.g., A_{2,1}=HASH(A_{3,1}∥A_{3,2}), where ∥ refers to concatenation). Other manners of determining the values of the cryptographic hash tree nodes may be used in some cases.

The cryptographic hash trees 206A and 206B may be used in conjunction with an OTS scheme to authenticate a verification key sent in a digital signature. For example, referring to FIG. 2, a signing node may use the signing key X_{A1} to generate an OTS for a message. The signing node may then send the OTS, an index indicating that the signing key) X_{A1} was used, the verification key X_{A1} associated with the signing key X_{A1}, and an authentication path in the cryptographic hash tree to a recipient (e.g., in a digital signature accompanying a message), and the recipient may authenticate the verification key using the authentication path and a public key. In some instances, the public key is or includes the root node A₀ 222A of the cryptographic hash tree 206A, and the authentication path includes a set of nodes in the cryptographic hash tree 206A that are used to authenticate the verification key X_{A1} by comparing the public key to an output of a hash function applied one or more times to the verification key Y_{A1}. For example, where the root node 222A of the cryptographic hash tree 206A is the public key, the authentication path for the signing/verification key pair (X_{A1}, Y_{A1}) is the set of values for nodes (A_{3,2}, A_{2,2}, A_{1,2}), since each of those nodes are used to authenticate the verification key Y_{A1} against the public key (root node 222A, A₀). More specifically, to authenticate the verification key Y_{A1}, the recipient in this example would apply a known hash function to the verification key X_{A1} sent with the message to yield the value of node A_{3,1}. The recipient would then use the values of nodes A_{3,2}, A_{2,2}, and A_{1,2} to determine a value for the root node A₀. This may be done, for example, by determining the value for A_{2,1} by applying a hash function to a concatenation of the values of nodes A_{3,1} and A_{3,2}, determining the value for A_{1,1} by applying a hash function to a concatenation of the values of nodes A_{2,1} and A_{2,2}, and determining the value for A₀ by applying a hash function to a concatenation of the values of nodes A_{1,1} and A_{1,2}. The determined value of A₀ may then be compared to the value of the public key, and if the values match then the verification key is authenticated.

As shown in FIG. 2, the public keys of both cryptographic hash trees 206A, 206B are certified by the digital certificate 202, so that an entity verifying the OTS signature can also verify the public keys. In the example shown, the public keys for the respective hash trees 206A, 206B include the respective root nodes 222A and 222B (and possibly additional information), and the individual public keys are combined to form a composite public key 240, which is inserted in the public key field of the digital certificate 204. The composite public key 240 can be constructed by concatenation, in which the key size is increased, e.g., Composite Public Key=pk₁|pk₂| . . . | pkₙ. Alternatively, the composite public key 240 can be hashed after combination to maintain the size of the composite public key at the size of a single key, e.g., Composite Public Key=HASH(pk₁|pk₂| . . . | pkₙ). The composite public key 240 can then be stored 204 in a digital certificate 202, along with any additional information enabling use of the composite public key.

When combining public keys from similar trees (e.g., the same height, same hashing algorithms), this type information can be stored as a global attribute in the digital certificate 202. When combining trees of different types, the tree information (e.g., tree type, tree size, tree name) can be stored either within the structure concatenating the public keys or in a global attribute specifying the tree order. In an example implementation, this type information can be stored in the digital certificate 204. The example digital certificate 204 can be a root CA certificate, an end-entity certificate, or an intermediate CA certificate.

FIG. 3 is a flowchart showing an example process 300 of generating a certificate for a composite public key. The example process 300 can be performed, for example, by computer systems that can exchange information over a network. In some cases, the process 300 is executed by one or more computing devices in an enterprise. The process 300 may include additional or different operations, and in some cases, certain operations may be performed in a different order, or they may be combined or performed in parallel.

The example process 300 shown in FIG. 3 includes operations performed by a certificate owner 302 and a certificate authority 304. In the example shown in FIG. 3, the certificate owner 302 and the certificate authority 304 represent two distinct entities in a public key infrastructure (PKI). The certificate authority 304 can be, for example, a root certificate authority or a subordinate certificate authority. The certificate owner 302 can be another certificate authority (e.g., a subordinate certificate authority) or any other type of entity in a PKI (e.g., user, user account, device or machine, software module, or other types of entity). In the example shown in FIG. 3, the certificate authority 304 issues a digital certificate to the certificate owner 302. The digital certificate issued in the process 300 can be, for example, a digital certificate of the type shown in FIG. 2 or another type of digital certificate. The digital certificate issued in the process 300 can be a root CA certificate, an intermediate CA certificate, or an end-entity certificate.

When the example process 300 is executed in the context of FIG. 1, operations of the certificate owner 302 may be performed by one of the entity nodes (102 or 104) or one of the certificate authority nodes (114 or 116), and operations of the certificate authority may be performed by one of the certificate authority nodes (114 or 116). For example, the process 300 may be initiated by either of the entity nodes 102, 104 communicating a certificate signing request over the network 106 to either of the certificate authority nodes 114, 116 to obtain a signed certificate.

At 310, signing keys and verification keys are generated by the certificate owner 302. The signing keys and verifications keys are generated for a one-time signature (OTS) scheme. For example, the signing keys and verification keys may be generated as described with respect to FIG. 2 or in another manner. In the example shown in FIG. 3, the signing keys and verification keys are generated to form the basis of multiple cryptographic hash trees. For instance, multiple subsets of signing keys and verification keys can be generated, such that each subset forms the basis of a respective cryptographic hash tree. Each subset can be generated by a respective hardware security module in some cases.

At 312, cryptographic hash trees are generated by the certificate owner 302. The cryptographic hash trees are generated at 312 from the verification keys generated at 310. For instance, each cryptographic hash tree may be generated from a respective subset of the verification keys generated at 310. The cryptographic hash trees may be generated as described with respect to FIG. 2 or in another manner. For instance, each of the cryptographic hash trees may include a collection of nodes; the collection of nodes can include a root node and multiple leaf nodes and layers of intermediate nodes between the root nodes and the leaf nodes, where each of the leaf nodes is generated from respective one of the verification keys. Some or all of the cryptographic hash trees generated at 312 may be of the same type and have the same properties. In some cases, cryptographic hash trees of multiple different types and sizes may be generated. For instance, cryptographic hash trees of multiple distinct heights may be generated, cryptographic hash trees for multiple distinct OTS schemes may be generated, cryptographic hash trees may be generated by different types of functions, etc.

In some cases, the cryptographic hash trees are stored on distinct hardware security modules (HSMs). For example, each of the plurality of cryptographic hash trees can be generated by and stored on a respective one of the HSMs. In some cases, each of the HSMs includes a cryptographic processor that generates one of the cryptographic hash trees and then stores the cryptographic hash tree in a local memory of the HSM. Accordingly, the cryptographic hash trees can be generated in a standard compliant and secure manner, to preserve the cryptographic security and integrity of the tree contents.

At 314, public keys are generated by the certificate owner 302. Each public key is associated with a respective one of the cryptographic hash trees. The public key associated with a cryptographic hash tree can be used to verify a verification key associated with the cryptographic hash tree. In some cases, each public key includes the root node of the cryptographic hash tree that the public key is associated with. In addition to the root note, each public key may include additional information related to the cryptographic hash tree. The additional information can be, for example, a string or another type of data object that identifies the cryptographic hash tree. For instance, a unique name can be assigned to each cryptographic hash tree, and a string containing the unique name can be included in the public key along with the root node

At 316, a composite public key is generated by the certificate owner 302. The composite public key generated at 316 contains some or all of the public keys generated at 314. Accordingly, the composite public key is generated by combining the public keys associated with respective cryptographic hash trees that are stored on distinct HSMs. The public keys may be combined, for example, by concatenating them. In some cases, the composite public key is generated by hashing a concatenation of the public keys. Accordingly, the composite public key can be a concatenation of the public keys, or a data object derived from a concatenation or other combination of the public keys.

At 318, a certificate signing request (CSR) is generated by the certificate owner 302, and at 320, the CSR is sent to the certificate authority 304. The CSR includes the composite public key generated at 316 and information identifying the certificate owner 302. For instance, the CSR may include a common name, organization name, organizational unit, an email address, or other information identifying the certificate owner 302. In some cases, the CSR can conform to a standard, for example, a CSR for an X.509 certificate or another type of standardized certificate. The CSR can be sent to the certificate authority 304, for example, over a public channel such as the Internet or another communication channel.

At 322, the certificate authority 304 generates a digital certificate based on the CSR from the certificate owner 302. To generate the digital certificate, the certificate authority 304 uses the certificate authority's private key to generate a digital signature over the information in the CSR (including the composite public key). The digital certificate can include the composite public key (generated at 316) in the public key field, and the digital signature of the certificate authority 304 can be populated into a signature field. The digital signature of the certificate authority 304 binds the composite public key with an identity of the certificate owner 302. The digital signature of the certificate authority 304 can be generated by a suitable digital signature process, and can be verified by another entity based on the certificate authority's public key (which is associated with the certificate authority's private key that was used to generate the certificate authority's digital signature).

Accordingly, the digital certificate can be used (e.g., by another entity) along with the public key of the certificate authority 304 to validate the composite public key. In some implementations, the digital certificate also includes information related to the cryptographic hash trees associated with the public keys contained in the composite public key. For example, a global attribute may store information describing the type, size, or other properties of the cryptographic hash trees. In some cases, information describing the type, size, or other properties of the cryptographic hash trees may be stored in a structure containing the concatenated public keys.

At 324, the certificate authority 304 sends the digital certificate to the certificate owner 302. The digital certificate can be sent to the certificate owner 302, for example, over a public channel such as the Internet or another communication channel. The certificate owner 302 can then use the digital certificate in conjunction with the signing keys, the verification keys and the cryptographic hash trees generated at 310 and 312. For example, when the certificate owner 302 generates a digital signature using one of the signing keys, the digital signature can be provided to another entity along with the digital certificate (as well as other information such as, for example, a verification key and one or more nodes from the associated cryptographic hash tree). The other entity (a relying entity) can then validate the public key using the digital certificate, and then the relying entity can authenticate the digital signature using the verification keys and the composite public key.

As described above, the composite public key may contain public key information for all the cryptographic hash trees, but only one of the public keys can authenticate any given digital signature. In particular, a digital signature generated by a particular signing key can be authenticated only by the public key that is associated with the cryptographic hash tree based on the particular signing key. Thus, the relying entity can identify, within the composite public key, an appropriate public key to verify each digital signature. In some cases, the relying entity can attempt to authenticate a digital signature using all public keys in the composite public key; if one of them works, then the authentication succeeds; if none of them works, then the authentication fails. In some cases, the relying entity can select one of the public keys based on information provided with the digital signature. For instance, a digital signature may be sent along with information identifying the cryptographic hash tree that is associated with the signing key used to generate the digital signature, and that information may be used to select a particular public key from the composite public key. As an example, the digital signature may be sent along with a name of the cryptographic hash tree, and the public key that contains the name of the cryptographic hash tree can be selected. The relying entity may select or otherwise identify an appropriate public key in another manner.

Some of the subject matter and operations described in this specification can be implemented in digital electronic circuitry, or in computer software, firmware, or hardware, including the structures disclosed in this specification and their structural equivalents, or in combinations of one or more of them. Some of the subject matter described in this specification can be implemented as one or more computer programs, i.e., one or more modules of computer program instructions, encoded on a computer storage medium for execution by, or to control the operation of, data-processing apparatus. A computer storage medium can be, or can be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate physical components or media (e.g., multiple CDs, disks, or other storage devices).

Some of the operations described in this specification can be implemented as operations performed by a data processing apparatus on data stored on one or more computer-readable storage devices or received from other sources.

The term “data-processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program, or in multiple coordinated files (e.g., files that store one or more modules, sub programs, or portions of code). A computer program can be deployed to be executed on one computer or on multiple computers that are located at one site or distributed across multiple sites and interconnected by a communication network.

Some of the processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and processors of any kind of digital computer. Generally, a processor will receive instructions and data from a read-only memory or a random-access memory or both. Elements of a computer can include a processor that performs actions in accordance with instructions, and one or more memory devices that store the instructions and data. A computer may also include or be operatively coupled to receive data from or transfer data to, or both, one or more mass storage devices for storing data, e.g., non-magnetic drives (e.g., a solid-state drive), magnetic disks, magneto optical disks, or optical disks. However, a computer need not have such devices. Moreover, a computer can be embedded in another device, e.g., a phone, an electronic appliance, a mobile audio or video player, a game console, a Global Positioning System (GPS) receiver, an Internet-of-Things (IoT) device, a machine-to-machine (M2M) sensor or actuator, or a portable storage device (e.g., a universal serial bus (USB) flash drive). Devices suitable for storing computer program instructions and data include all forms of non-volatile memory, media, and memory devices, including by way of example semiconductor memory devices (e.g., EPROM, EEPROM, flash memory devices, and others), magnetic disks (e.g., internal hard disks, removable disks, and others), magneto optical disks, and CD ROM and DVD-ROM disks. In some cases, the processor and the memory can be supplemented by, or incorporated in, special purpose logic circuitry.

To provide for interaction with a user, operations can be implemented on a computer having a display device (e.g., a monitor, or another type of display device) for displaying information to the user and a keyboard and a pointing device (e.g., a mouse, a trackball, a tablet, a touch sensitive screen, or another type of pointing device) by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to, and receiving documents from, a device that is used by the user; for example, by sending web pages to a web browser on a user's client device in response to requests received from the web browser.

A computer system may include a single computing device, or multiple computers that operate in proximity or generally remote from each other and typically interact through a communication network. Examples of communication networks include a local area network (“LAN”) and a wide area network (“WAN”), an inter-network (e.g., the Internet), a network comprising a satellite link, and peer-to-peer networks (e.g., ad hoc peer-to-peer networks). A relationship of client and server may arise by virtue of computer programs running on the respective computers and having a client-server relationship to each other.

In a general aspect of the examples described here, public keys may be certified for multiple cryptographic hash trees.

In a first example, a plurality of cryptographic hash trees may be generated. Each cryptographic hash tree may include a root node and a plurality of lowest-level (leaf) nodes. The leaf nodes may be generated from respective verification keys for a OTS scheme. The plurality of cryptographic hash trees may be stored on a plurality of HSMs, and each cryptographic hash tree may be stored on a respective one of the plurality of HSMs. A plurality of public keys may be generated for the plurality of cryptographic hash trees, and each public key may be associated with a respective one of the plurality of cryptographic hash trees. A composite public key may be generated for the plurality of hash trees such that the composite public key includes the plurality of public keys. A digital certificate that certifies the composite public key may be obtained, and the digital certificate may include the composite public key and a digital signature of a certificate authority.

Implementations of the first example may include one or more of the following features. The public key associated with each cryptographic hash tree may include the root node of the cryptographic hash tree and additional information related to the cryptographic hash tree. Generating the composite public key may include concatenating the plurality of public keys. The composite public key may be a hash value and generating the composite public key may include applying a hash function to a concatenation of the plurality of public keys. A plurality of signing keys may also be generated for the OTS scheme. Verification keys may be generated from the signing keys. Each verification key may be generated from a respective signing key. Each cryptographic hash tree may be generated from a distinct subset of the verification keys. The digital certificate may be provided for use with the verification keys and the signing keys. Each of the plurality of cryptographic hash trees may be generated by, and stored on, a respective one of the plurality of HSMs.

In a second example, a computing system may include one or more processors and memory storing instructions that are operable, when executed by the one or more processors, to perform the features of the first example.

Implementations of the first and second examples may also include one or more of the following features. Each HSM may include one or more module processors. Each HSM may include a module memory storing instructions that may be operable, when executed by the one or more module processors to generate one of the plurality of cryptographic hash trees. The instructions may be further operable to store one of the plurality of cryptographic hash trees on a local memory of an HSM. An implementation of the second example may include a computer device with one or more device processors. An implementation of the second example may also include a device memory storing instructions that are operable when executed by the one or more module processors to generate the composite public key.

In some implementations, a computing system includes one or more processors and memory storing instructions that are operable when executed by the one or more processors to perform one or more operations of the first example. In some implementations, a computer-readable medium stores instructions that are operable when executed by a data processing apparatus to perform one or more operations of the first example.

While this specification contains many details, these should not be understood as limitations on the scope of what may be claimed, but rather as descriptions of features specific to particular examples. Certain features that are described in this specification or shown in the drawings in the context of separate implementations can also be combined. Conversely, various features that are described or shown in the context of a single implementation can also be implemented in multiple embodiments separately or in any suitable sub combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be used. Moreover, the separation of various system components in the implementations described above should not be understood as requiring such separation in all implementations, and it should be understood that the described program components and systems can generally be integrated together in a single product or packaged into multiple products.

A number of embodiments have been described. Nevertheless, it will be understood that various modifications can be made. Accordingly, other embodiments are within the scope of the following claims.

What is claimed is:

1. A computer-implemented cryptographic method comprising:
generating a plurality of cryptographic hash trees, each cryptographic hash tree comprising a root node and a plurality of lowest-level nodes, the lowest-level nodes being generated from respective verification keys for a one-time signature (OTS) scheme;
storing the plurality of cryptographic hash trees on a plurality of hardware security modules, each of the plurality of cryptographic hash trees being stored on a respective one of the plurality of hardware security modules;
generating a plurality of public keys for the plurality of cryptographic hash trees, each public key being associated with a respective one of the cryptographic hash trees;
generating a composite public key for the plurality of hash trees, the composite public key comprising the plurality of public keys; and
obtaining a digital certificate that certifies the composite public key, the digital certificate comprising the composite public key and a digital signature of a certificate authority.

2. The method of claim 1, wherein the public key associated with each cryptographic hash tree comprises the root node of the cryptographic hash tree and additional information related to the cryptographic hash tree.

3. The method of claim 2, wherein generating the composite public key comprises concatenating the plurality of public keys.

4. The method of claim 2, wherein the composite public key is a hash value, and generating the composite public key comprises applying a hash function to a concatenation of the plurality of public keys.

5. The method of claim 1, comprising:
generating a plurality of signing keys for the OTS scheme;
generating the verification keys from the signing keys, each verification key being generated from a respective one of the signing keys,
wherein each of the cryptographic hash trees is generated from a distinct subset of the verification keys.

6. The method of claim 1, comprising providing the digital certificate for use with the verification keys and the signing keys.

7. The method of claim 1, wherein each of the plurality of cryptographic hash trees is generated by and stored on a respective one of the plurality of hardware security modules.

8. A computing system comprising:
one or more processors; and
memory storing instructions that are operable when executed by the one or more processors to perform operations comprising:
generating a plurality of cryptographic hash trees, each cryptographic hash tree comprising a root node and a plurality of lowest-level nodes, the lowest-level nodes being generated from respective verification keys for a one-time signature (OTS) scheme;
storing the plurality of cryptographic hash trees on a plurality of hardware security modules, each of the plurality of cryptographic hash trees being stored on a respective one of the plurality of hardware security modules;
generating a plurality of public keys for the plurality of cryptographic hash trees, each public key being associated with a respective one of the cryptographic hash trees;
generating a composite public key for the plurality of hash trees, the composite public key comprising the plurality of public keys; and
obtaining a digital certificate that certifies the composite public key, the digital certificate comprising the composite public key and a digital signature of a certificate authority.

9. The system of claim 8, wherein the public key associated with each cryptographic hash tree comprises the root node of the cryptographic hash tree and additional information related to the cryptographic hash tree.

10. The system of claim 9, wherein generating the composite public key comprises concatenating the plurality of public keys.

11. The system of claim 9, wherein the composite public key is a hash value, and generating the composite public key comprises applying a hash function to a concatenation of the plurality of public keys.

12. The system of claim 9, the operations comprising:
generating a plurality of signing keys for the OTS scheme;
generating the verification keys from the signing keys, each verification key being generated from a respective one of the signing keys,
wherein each of the cryptographic hash trees is generated from a distinct subset of the verification keys.

13. The system of claim 8, the operations comprising providing the digital certificate for use with the verification keys and the signing keys.

14. The system of claim 8, comprising the plurality of hardware security modules, wherein each of the plurality of hardware security modules comprises:
one or more module processors; and
a module memory storing instructions that are operable when executed by the one or more module processors to:
generate a respective one of the plurality of cryptographic hash trees; and
store the respective one of the plurality of cryptographic hash trees on a local memory of the hardware security module.

15. The system of claim 14, comprising a computer device comprising:
one or more device processors; and
a device memory storing instructions that are operable when executed by the one or more module processors to generate the composite public key.

16. A non-transitory computer-readable medium storing instructions that are operable, when executed by data processing apparatus, to perform operations comprising:
generating a plurality of cryptographic hash trees, each cryptographic hash tree comprising a root node and a plurality of lowest-level nodes, the lowest-level nodes being generated from respective verification keys for a one-time signature (OTS) scheme;
storing the plurality of cryptographic hash trees on a plurality of hardware security modules, each of the plurality of cryptographic hash trees being stored on a respective one of the plurality of hardware security modules;
generating a plurality of public keys for the plurality of cryptographic hash trees, each public key being associated with a respective one of the cryptographic hash trees;
generating a composite public key for the plurality of hash trees, the composite public key comprising the plurality of public keys; and
obtaining a digital certificate that certifies the composite public key, the digital certificate comprising the composite public key and a digital signature of a certificate authority.

17. The computer-readable medium of claim 16, wherein the public key associated with each cryptographic hash tree comprises the root node of the cryptographic hash tree and additional information related to the cryptographic hash tree.

18. The computer-readable medium of claim 17, wherein generating the composite public key comprises concatenating the plurality of public keys.

19. The computer-readable medium of claim 17, wherein the composite public key is a hash value, and generating the composite public key comprises applying a hash function to a concatenation of the plurality of public keys.
